(19) United States
(12) Patent Application Publication
(10) Pub. No.: US 2010/0034098 A1
(43) Pub. Date: Feb. 11, 2010

(54) Towards Efficient Large-Scale Network Monitoring and Diagnosis Under Operational Constraints

(75) Inventors: Jia Wang, Randolph, NJ (US); Yan Chen, Glenview, IL (US); Dan Pei, Jersey City, NJ (US); Yao Zhao, Chicago, IL (US); Zhaosheng Zhu, Evanston, IL (US)

Correspondence Address: AT&T Legal Department - HB;Patent Docketing, One AT&T Way, Room 2A-207, Bedminster, NJ, 07921, US

(73) Assignee: AT&T INTELLECTUAL PROPERTY I, LP, Reno, NV (US)

(21) Appl. No.: 12/186,096

(22) Filed: Aug. 5, 2008

(51) Int. Cl. G06F 11/30

(52) U.S. Cl. 370/242

(57) ABSTRACT

A system and methods are disclosed that provide a continuous monitoring and diagnosis system for ISP IP/VPN backboneExt networks. The system includes two phases: 1) a monitor setup phase which selects candidate routers as monitors and the paths to be measured by the monitors, and 2) a continuous monitoring and diagnosis phase.

### BACKGROUND OF THE INVENTION

1. Field of the Invention

The present invention generally relates to network monitoring, and more particularly to network monitoring and diagnosis under operational constraints.

2. Brief Description of the Related Art

Recently the Internet has witnessed an unprecedented growth in terms of the scale of its infrastructure, the traffic load, as well as the abundant applications. Today, large Internet Service Providers (ISPs) usually provide managed Internet access service to their customers as well as the emerging Virtual Private Network (VPN) service to corporations and organizations. Efficiently monitoring the performance of ISP networks and quickly diagnosing the faulty links are critical for ISPs to provide reliable and high quality services. For example:

Internet service providers have contract network service level agreements (SLAs) with their customers, specifying the performance (such as network availability, loss rates and latency) of the Internet access services that the ISPs promise to achieve. From the ISPs' perspective, continuous monitoring of network performance not only helps reporting and diagnosing possible SLA violations, but also provides useful input to many important network operations such as traffic engineering and network provisioning.

Recently the Internet has also witnessed an exponential growth for MPLS-based IP Virtual Private Networks (VPN). Because a VPN provider is often the sole provider of connectivity among a customer's sites, continuous monitoring and diagnosis of VPN performance are of crucial importance for the VPN service providers to ensure the reliability and quality of service, especially given that VPNs often carry important business applications, such as VoIP and financial transactions that do not react well to even small traffic disruptions.

Today, ISPs heavily rely on the standard passive monitoring approach via SNMP, which polls the status of each routers/switches. However, such SNMP based monitoring approach is unable to investigate every device such as fibers, and to monitor path-level features such as reachability, latency and bandwidth. Therefore, active measurements are important complement to the SNMP based monitoring approach and are also used by ISPs widely. Large-scale network monitoring and diagnosis problems have been relatively well studied in the literature. Basically, to be cost effective and scalable, only a portion of network paths are measured simultaneously and metrics of other unmeasured paths and links are inferred. However, existing work does not consider the real-world operational constraints and the topology requirements as described below which raise new challenges.

Generally, there are two types of constraints: load constraints and monitor/path selection constraints. The reasons from load constraints are: 1) access links and peering links are often not over-provisioned; and 2) when congestions happens, we do not want the measurement traffic to further stress the load. Thus rules are often put in place by the network designer/operator so that the measurement/probe traffic load cannot exceed some threshold. The other type of constraints is described in more details in Section 2.1.2. For example, some of the customer routers are beyond the control of the service provider, thus they cannot be monitors.

The number of routers in networks to be monitored can be as large as hundreds of thousands. It is inefficient to install monitors on all routers, especially given that sometimes hardware measurement boxes which are attached to routers cannot be easily installed with software to perform flexible active measurements. Therefore, minimizing the number of monitors is desirable to reduce the installation and management cost.

When some faulty paths are detected through monitoring, there is a need to diagnose and locate the error links as soon as possible. Thus, the following two tasks have to be completed in real-time: 1) selection of extra paths for diagnosis and 2) location of the faulty links based on the results of path level measurements.

In addition, for both IP and VPN services, the access links that customers use to connect to an ISP (IP or VPN) backbone network are more important to be carefully monitored than the links in the back-bone itself because the access links tend to have less bandwidth and be more vulnerable for congestion/failures. Some customer routers are also managed by the ISP. As used herein, we reference an extended back-bone network with access links and customer routers a backbone extended network (in short, backboneExt). Interestingly, the real IP/VPN backboneExt networks usually have the star-like topologies where a backbone edge router connects to a large number of customer routers. Such star-like topologies further stress the three constraints above and make it infeasible to run all the path measurement simultaneously as used in most existing monitoring systems.

Accordingly, there is a need in the art to address the above issues.

### SUMMARY OF THE INVENTION

A system and methods are disclosed that provide a continuous monitoring and diagnosis system for ISP IP/VPN backboneExt networks. The system includes two phases: 1) a monitor setup phase which selects candidate routers as monitors and the paths to be measured by the monitors, and 2) a continuous monitoring and diagnosis phase.

First, the methods employed by the system select as few monitors as possible that can conduct simultaneous path measurements to monitor the whole network under the operational constraints. Considering the operational constraints, the system models the problem as a unique combination of the two-level nested Set Cover problem and constraint satisfaction problem. The system then provides a scalable greedy-assisted linear programming algorithm for it providing a smooth efficiency-optimality tradeoff.

Secondly, to further reduce the number of monitors, the system employs a multi-round measurement approach which is a tradeoff between measurement frequency and monitors deployment/management cost. With the single-round measurement algorithms as the basis, the system provides three algorithms to schedule the path measurements in different rounds so that in each round the monitors and links are not over-loaded.

Finally, the system not only detects the existence of some fault (e.g. large loss rates or latency) but also needs to quickly identify exactly which links are faulty so that operators can take actions for mitigation. The system also provides a continuous monitoring and diagnosis mechanism which quickly identifies the faulty links after the discovery of faulty paths.

In one aspect, a method for monitoring and diagnosing a back-bone network having access links and customer routers is disclosed. The method includes selecting a monitor from the plurality of customer routers and data paths to be measured by the monitor, and detecting a link failure between the customer routers in response to measurement information received from the monitor.

Preferably, the method includes selecting a plurality of monitors from the customer routers, each of the plurality of monitors selecting a subset of data paths to measure such that a majority of data links of the back-bone network is included in at least one measured path.

In one embodiment, the method includes probing iteratively data paths associated with each of the plurality of monitors. The method also can include assigning measurement tasks to each of the monitors, and collecting measurement results from the monitor. In one embodiment, the method includes selecting the monitor using a greedy algorithm. In another embodiment, the method includes selecting the monitor using relaxed linear programming.

Preferably, the method includes selecting a minimum number of additional data paths to measure in response to receiving the measurement information. The method can further include combining the minimum number of additional paths with the measurement information to identify said link failure. In one embodiment, a linear algebra technique is used for selecting the minimum number of additional data paths. The method can also include detecting the link failure on a data path using at most two links.

In another aspect, a system for monitoring and diagnosing a back-bone network having access links and customer routers includes a monitor module arranged to select a monitor from said plurality of customer routers and data paths to be measured by the monitor, and a diagnosis module arranged to detect a link failure between the customer routers in response to measurement information received from the monitor.

In one embodiment, the monitor module selects a plurality of monitors from the customer routers, each of the plurality of monitors selects a subset of data paths to measure such that a majority of data links of the back-bone network is included in at least one measured path. Preferably, each of the plurality of monitors iteratively probes data paths associated with itself.

The system can also include a coordination module that is adapted to 1) assign measurement tasks to each of the monitors and 2) collect measurement results from the monitor. In one embodiment, the monitor module selects the monitor using a greedy algorithm. In another embodiment, the monitor module selects the monitor using relaxed linear programming.

Preferably, the diagnosis module selects a minimum number of additional data paths to measure in response to receiving the measurement information. In one embodiment, the diagnosis module combines the minimum number of additional paths with the measurement information to identify the link failure.

In one embodiment, the diagnosis module uses a liner algebra technique to select the minimum number of additional data paths. Preferably, the diagnosis module detects the link failure on a data path having at most two links.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram illustrating an example Layer-3 IP VPN infrastructure.

FIG. 2 is a block diagram of the systems architecture.

FIG. 3 is an example distribution of customer routers connected to per core router.

FIG. 4 illustrates a greedy algorithm for monitor selection.

FIG. 5 is a proof for applying random rounding to solutions of the monitor selection LP problem.

Like reference symbols in the various drawings indicate like elements.

### DETAILED DESCRIPTION OF THE EMBODIMENTS

From an Internet Service Provider (ISP) operational perspective, the goals of network monitoring are two-fold. First, ISPs need to actively measure or infer the performance of all the possible paths through the backbone net-works (for IP and VPN). Second, ISPs also need to quickly identify the root cause of the performance degradation or service disruption. The monitoring problem can be divided into two phases: setup phase for monitor selection, and continuous monitoring and fault diagnosis phase. The present system defines each of the sub-problems into two phases. The two phases are coupled tightly, because the goal of monitor selection is to optimize the second monitoring and diagnosis phase.

### 1.0 Background on IP BackboneExt and VPN Back-boneExt Networks

An IP backbone consists of a set of Points-of-Presence (POPs) connected by high bandwidth backbone links. A PoP is a physical location that houses servers, routers, ATM switches and digital/analog call aggregators. POPs are usually located in Internet exchange points and colocation centres. Within a POP, IP backbone routers connect other POPs or peer with other backbone networks. Access routers, which aggregate traffic from customer routers via access links, are attached to the backbone routers. Typically, ISPs pay more attention to the access links, which tend to be more vulnerable for congestion/failures. In addition, ISPs often manage (although do not own) some or all of the customer routers. Therefore, the IP backbone network extended with managed customer routers and links (called IP backboneExt network) are also prevelant.

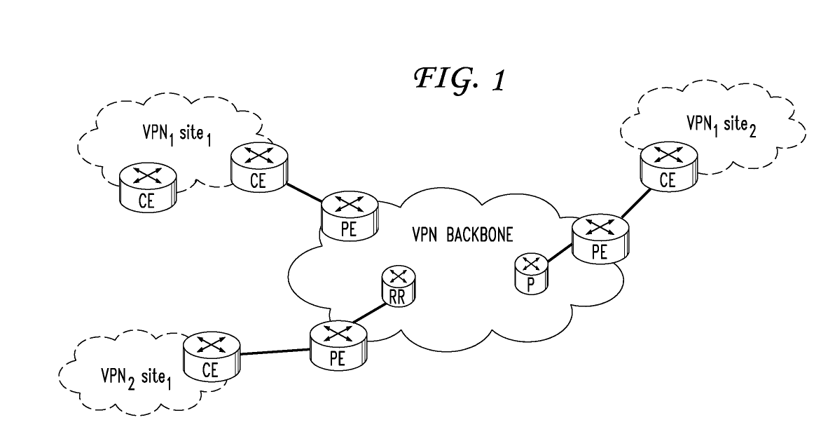

A layer-3 Virtual Private Network (VPN) refers to a set of sites among which communication takes place over a shared network infrastructure called a VPN backbone. FIG. 1 shows a VPN back-bone with two VPNs and three sites. Customer Edge device routers (CE routers) are connected to routers in the Provider Edge device routers (PE routers) via external BGP (eBGP). Other routers in the provider network are called Provider's device routers (P routers). Similarly, the VPN backbone network (including P and PE routers) extended with CE routers is called VPN backboneExt network in this paper. Each PE router maintains a Virtual Routing and Forwarding (VRF) table for each VPN so that routes from different VPN customers remain distinct and separate even if multiple VPN customers use the same IP address space. Internal BGP (iBGP) is used to distribute the VPN routes within the VPN backbone. Within the VPN backbone, Multi-Protocol Label Switching (MPLS) tunnels between PEs are used to forward packets.

### 1.1 Measurement Constraints

Active measurements preferably avoid interrupting the normal network traffic or overloading network or computation resources. The present invention addresses the following measurement constraints:

Monitor/node constraint. Each monitor has limited probing ability (e.g., 50 probes/second). Given a fixed measurement over-head on each measured path, a monitor thus can measure only a limited number of paths simultaneously. This constraint is called monitor constraint or node constraint.

Link constraint. Every link has its own bandwidth. The measurement overhead on a link should not exceed a certain portion of the link bandwidth (e.g., 1%). We call such constraint link bandwidth constraint or link constraint in short.

Measurement path selection constraint. VPN provides the traffic isolation between different customers so only the sites/route within the same VPN can communicate with each other. The path selected for measurement in BScope needs to satisfy this constraint too. Meanwhile the IP backbone/backbone Ext networks usually do not have such constraints because any pair of routers can communicate between each other. Note the measured paths are round-trip paths because the non-monitor routers can simple reply to probes.

Monitor node selection constraint. Not all the routers can be selected as monitors for various business and hardware reasons. For example, some CE routers are not managed by the VPN provider. The system defines the routers that can be monitors as candidate routers.

### 1.2 Monitor Setup Phase

For existing Internet tomography works, the design problem is mainly to select a path set that satisfies some optimization goal to measure. For example, in one work, a minimal set of paths that covers all the links is the selection goal; while in another work, a path set corresponds to a basis of the path matrix is selected. However, the present invention is unique due to the four challenges introduced previously.

Note that the monitor setup problem includes the path selection problem because the ultimate goal is to monitor the networks by measuring some paths via the monitors. The operational constraints already result in a very challenging monitor (as well as path) selection problem and hence the system considers the simplest path selection goal (i.e., covering all links), but can be adapted readily for more sophisticated path selection goals.

As used herein, the term monitor selection is defined as selecting minimal number of monitors from certain monitor candidates, which can measure a certain path set that covers all links in the measurement phase under the given measurement constraints.

### 1.3 Monitoring and Fault Diagnosis Phase

System monitoring involves periodically probing or inferring the path performance metrics, such as reachability, latency, loss rate, and so on.

When the monitoring system detects a path that fails to meet the SLA with customers, it is desirable to locate the faulty link which caused the violation. However, locating faulty links from path measurements is a hard problem. The system, given the fact that link performance metrics usually have constancy, considers the following problem: when faulty paths are discovered in the path monitoring phase, how to quickly select some paths under the operational constraints to be further measured so that the faulty link(s) can be accurately identified?

### 2.0 System Architecture

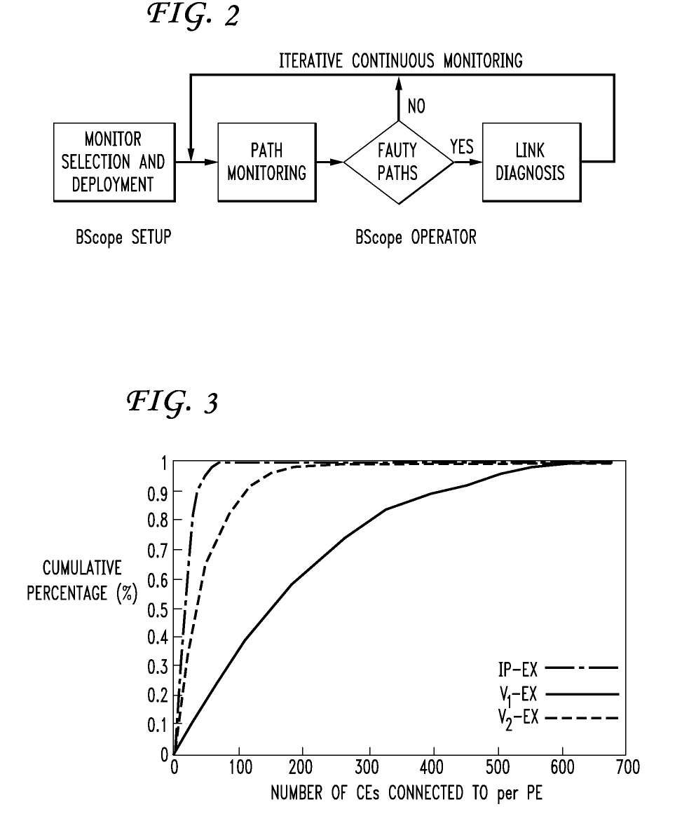

FIG. 2 shows the architecture of the system. The architecture has two components: monitor selection, and continuous monitoring and diagnosis. First, a set of monitors are selected according to the algorithms introduced below, and measurement machines or software are installed. The monitors probe paths and diagnose faulty links periodically. In each round, a set of paths is measured using active probing. Next, if some paths are found to be faulty, the diagnosis component of the system further locates the faulty links along the faulty paths. Additional path measurements are selected and conducted for this purpose. The system includes a centralized coordinator (like the network operation centers for many major ISPs) which assigns measurement tasks to monitors, collects the measurement results, detects faulty paths and identifies faulty links.

In one implementation, the diagnosis component is also compliant with the operational constraints and takes an exclusive round. For example, after every measurement round we need to identify which paths need to measure to locate the faulty links. Certainly we will reach smaller granularity if we measure more paths. But due to the operational constraints, eg., monitor constraint, link constraint and path constraint we can only choose a set of paths with satisfying these constraints. And we can not run the diagnosis component parallel with monitoring component, which will cause constraint violations if without extra resource budget, since it also consumes resources. So we need to implement our diagnosis component in another round in this case, ie., without extra resource budget. In another preferred embodiment, the diagnosis phase is parallel with the next round of path monitoring if some extra budget is allowed for the diagnosis phase (which may be rare) by network operators. Both the options are supported by the system framework. Network operators can choose either one based on their preference.

Monitor selection is the first component of the system. As described previously, among all the candidate routers, some are selected as monitors, and these monitors choose some paths to measure so that every (or most) link is contained in at least one measured path. Meanwhile, the measurements are compliant with the operational measurement constraints and the number of monitors desired to be minimized.

In one preferred embodiment, the system uses single-round monitoring, i.e., all the path measurement tasks are run simultaneously in a time period (i.e. a round) and utilizes one of two monitor selection methods for the single-round monitoring. In another preferred embodiment, the system uses multi-round monitoring which can be cost effective.

### 2.1 Single-Round Monitor Selection

The monitor selection problem is similar to the well-known Minimum Set Cover problem, which is an NP-hard problem. The set cover problem is to select a minimum number of these sets so that the sets you have picked contain all the elements that are contained in any of the sets in the input. One can simply imagine each link as an element and each candidate router as corresponding to a set. Preferably, a path covers a link if the link is on the path, and a link is associated with a router if the link is covered in at least one of the paths starting from the router. Hence a router's corresponding set contains all the links associated with the router. The Minimal Set Cover problem involves finding the smallest number of sets (or routers) that cover all the elements (or links). However, as a more realistic problem, the monitor selection problem faces the monitor constraints and link bandwidth limitations, which make the problem solved by the present invention much more complicated than the Set Cover problem, since in Set Cover problem we only need to cover all elements without considering any constraint.

Given these constraints, the classic approximation algorithms for the Set Cover problem (eg. Simple greedy algorithm of which the result has theoretical bound to the optimal) can not be directly applied to solve our problem. Accordingly, in the following paragraphs, two methods are disclosed that are used by the system, the greedy algorithm and the linear programming with random rounding algorithm to solve the monitor selection problem. Table 1 below illustrates the notations used in the paper. Note that xᵢ, yij, and Zₖ are 0-1 variables, as a router or path can be either selected or not selected and a link can be either covered or not covered.

| Symbols | Meaning |
|---|---|
| N | Number of routers |
| S | Number of links |
| Pᵢⱼ | The path from router i to router j |
| Lₖ | The kth link. Lₖ ∈ Pᵢⱼ if this link of path Pᵢⱼ |
| xᵢ | 1, if node i is a monitor, otherwise 0 |
| yᵢⱼ | 1, if path Pᵢⱼ is measured, otherwise 0 |
| zₖ | 1, if link k is covered, otherwise 0 |
| cᵢ | The number of paths that node i can measure |
| bₖ | Max number of measured paths that can pass link k |
| OPT | Number of monitors required in the best solution |

### 2.1.1 Greedy Monitor Selection Algorithm

Greedy algorithms are usually one of the most straightforward techniques to deal with some NP-hard problems. Especially in Minimum Set Cover problem, pure greedy algorithm turns out to be a log M-approximation algorithm, where M is the number of elements to cover. The greedy algorithm for Minimum Set Cover problem always picks the set which covers the most uncovered elements in every step.

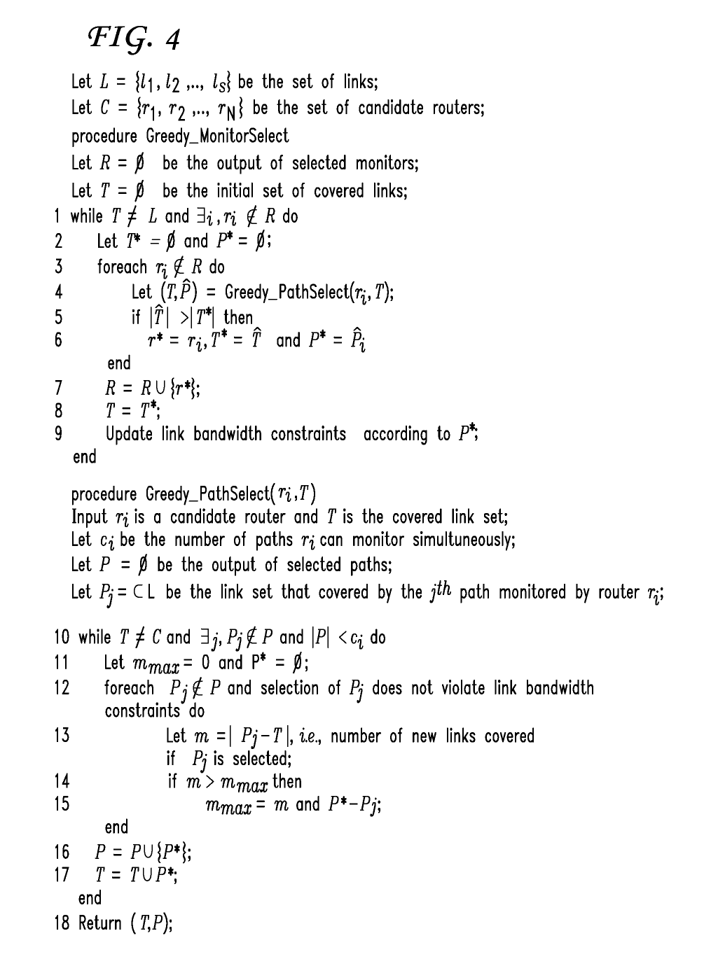

The present invention provides a simple greedy algorithm inspired by the greedy algorithm for Minimum Set Cover problem. Our monitor selection problem looks like a two-level nested Minimum Set Cover problem and Maximum k-Coverage problem to some extent. FIG. 4 illustrates the greedy algorithm for monitor selection. The objective is to greedily select one router at a time, which can monitor the largest number of links that have not been covered yet. The procedure shown in FIG. 4 describes this greedy algorithm.

However, the problem of evaluating the gain of adding a router as a monitor is a variant of Maximum k-Coverage problem. The Maximum k-Coverage problem is to select k sets from certain candidate sets so that the maximum elements are covered in the union of the selected sets. Maximum k-Coverage problem is an NP-hard problem and the similar greedy algorithm which is used in Minimum Set Cover problem is an e/e-1 approximation algorithm. Considering the paths as sets and links as elements, it is a k-Coverage problem to find out the number of links covered by a fixed number of paths that a router can simultaneously monitor, if we do not consider link bandwidth constraints. Similarly, our greedy algorithm also selects iteratively the path that can cover most new links while complying to the link constraints. Unfortunately, in our problem, the greedy algorithm can no longer be claimed to be an ^{e/e-1} approximation algorithm because the link bandwidth constraints may prevent the greedy algorithm from selecting the best path in a greedy step. So theoretically we do not have bound to the optimal result. But in practice using our techniques we can reach a good result. The procedure Greedy_PathSelect in FIG. 4 describes how to find out at most cᵢ paths that can cover the most non-covered links. Note, in line 10 the monitor constraints are considered, and in line 12 the link bandwidth constraints are enforced.

### 2.1.2 Linear Programming Based Monitor Selection Algorithm Integer Linear Programming.

In one preferred embodiment, the system first formulates the monitor minimization problem as an integer linear programming problem (ILP) as follows (See Table 1 for notations):

P: Minimize Σᵢxᵢ (1)

s.t. yᵢⱼ≦xᵢ, ∀ᵢ, ∀ⱼ (2)

Σⱼyᵢⱼ≦cᵢ·xᵢ, ∀ᵢ (3)

Σ_{∀i, ∀j, L}_{ₖ}_{εP}_{ᵢⱼ}yᵢⱼ≧1, ∀k (4)

Σ_{∀i, ∀j, L}_{ₖ}_{εP}_{ᵢⱼ}yᵢⱼ≦bₖ, ∀k (5)

Formula 1 is the minimization goal of the ILP, i.e., minimizing the number of monitors needed. Inequality (2) means a path can be measured if and only if the source router of the path is selected as a monitor. The monitor's constraint is formulated in Inequality (3). Inequality (4) shows that a link is covered when at least one of the paths containing the link is selected. Link bandwidth constraint is enforced by Inequality (5).

### Relaxed Linear Programming.

Integer linear programming is a NP-Complete problem and thus solving it may not be feasible. The system uses the classic relaxation techniques to relax the {0, 1}-ILP to a normal linear programming problems and then apply the random rounding scheme to achieve the optimality bound in terms of statistical expectation. To relax the integer linear programming to linear programming, the system adds the following constraints and removes the integer requirement of solution:

0≦xᵢ≦1, ∀i

0≦yᵢⱼ≦1, ∀i, ∀j

After relaxation both x and y are real numbers in the range [0,1], and the linear programming problem can be solved in polynomial time. Suppose the solution is x*ᵢ, y*ᵢⱼ, the system does random rounding in the following way:

$$\begin{matrix}{X}_{i} = \{ \begin{matrix}1 & with probability & {x}_{i}^{*} \\ 0 & with probability & 1 - {x}_{i}^{*}\end{matrix} & ( 6 ) \\ {Y}_{ij} = \{ \begin{matrix}1 & with probability {y}_{ij}^{*} / {x}_{i}^{*} , if {X}_{i} = 1 \\ 0 & otherwise\end{matrix} & ( 7 )\end{matrix}$$

If Xᵢ is rounded to 1, the corresponding router is selected as a monitor. Once a router is selected as a monitor, the paths starting from the router have some chance to be selected to measure with the probability y*ᵢⱼ/x*ᵢ. Then the value of zₖ, i.e. whether a link is covered or not, is decided by the rounded Yᵢⱼ. Let random variables X=ΣᵢXᵢ and Z=Σₖzₖ. We have the following theorem:

THEOREM 1. After applying random rounding to the solutions of the LP problem of the monitor selection, E(X)≦OPT, and E(Yᵢⱼ)=y*ᵢⱼ.

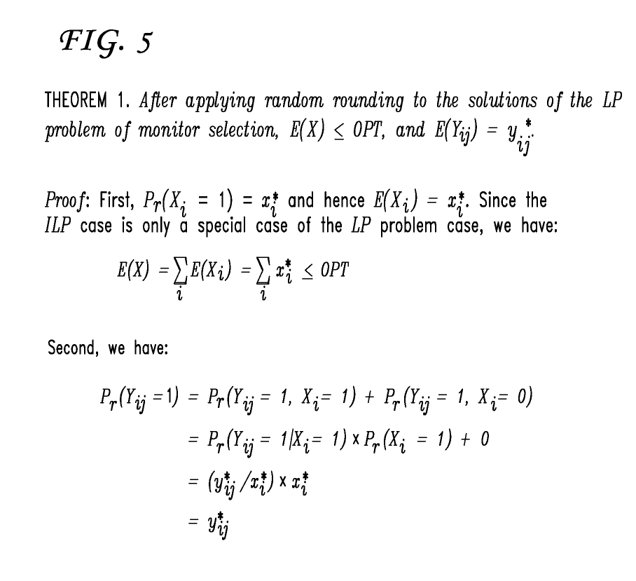

The proof of Theorem 1 is described in FIG. 5. Theorem 1 shows that in expectation the system selects no more than OPT monitors (OPT stands for the optimal result of the integer linear programming above). However, after rounding not all the links are covered. Note that in the standard LP algorithm for Minimum Set Cover problem, several random rounding results are combined together to obtain the 100% coverage of all the links. In our monitor selection problem, we can-not simply combine multiple results of random rounding because the combination will violate the monitor constraints and link band-width limitations. Therefore, we combine the LP-based algorithm with the greedy algorithm as described below to achieve 100% link coverage.

The system applies the following Theorem 2 to show that with pretty large probability, the random rounding results are not much larger than the expected results.
THEOREM 2. Let V be the sum of independent {0, 1} random variables, and μ>0 be the expected value of V. Then for ∀_{ε}>0,

Pᵣ(V≧(1+e)μ)<e^{-μmin{e,e}^{²}^{}/3}.

This equation gives the probability of possible violations after relaxation. For example, let μ=12 and E=1, then Pr (V>24)<0.018. According to Theorem 2, we can see that the probability of large violation of the node constraint and link constraint is small. For example, inequality 3 enforces the node constraint in the linear programming and after random rounding we have E[ΣⱼYᵢⱼ|≦Σⱼy*ᵢⱼ≦cᵢ. In our setup, usually one monitor can measure 12 paths simultaneously (i.e., cᵢ=12), hence we have Pᵣ(ΣⱼYᵢⱼ>2cᵢ)<0.018.

Since the system uses two approaches to reduce this violation. First, the system sets the constraints to be smaller than the constraint the network can accept. Second, the system executes random rounding several times to find the one which has minimal violations.

### Greedy-Assisted Relaxed Linear Programming

In one preferred embodiment, the system takes the LP results as a good starting point, which selects a certain number of monitors and paths associated with the monitors already. After removing the already covered links, the system continues to use the greedy algorithm to add more and more monitors until all the links are covered.

Although it is hard to prove the bound for the greedy-assisted LP algorithm, we expect it to be more efficient compared to the pure greedy algorithm because of the good starting point. Preferably, this hybrid approach is better than the pure greedy algorithm in terms of minimizing the number of monitors.

### 2.2 Multi-Round Monitor Selection

In the previous sections, the system dealt with the case where all the path measurements are done simultaneously in a single round (although the system repeats the measurements periodically). However, typical ISP IP and VPN backboneExt networks have star-like topologies which can make it inefficient to conduct the single round measurements when operational measurement constraints are critical in the monitor selection problem.

### 2.2. Star-Like Topology

Specifically, the backbone network is relatively small compared to the entire backboneExt network. For example, the backbone network usually has hundreds of routers and thousands of links, while the number for backboneExt is 1 to 2 orders of magnitude higher.

There are a large number (tens of thousands or even more) of customer routers connecting to the PE routers with one access link each. Usually, on average, tens or even hundreds of customer routers connect to a single provider edge router.

FIG. 3 shows the CDF of the degrees of PE routers that connect the customer routers in three real topologies (See Section 6.1 for de-tails of the topologies). The average degree of PE routers in the IP backbone network is about 30, while in one VPN network the average degree of PE routers reaches 300.

Typically an ISP's topology is designed based on technological and economic constraints. On one hand, a router can have a few high bandwidth connections or many low bandwidth connections or some combination in between. On the other hand, because it is cheaper to install and operate less number of links, traffic is aggregated at all levels of an ISP's network hierarchy, from its periphery all the way to its core. Meanwhile, there is a wide variability in customer's demand for network bandwidth and relatively low bandwidth is still widely needed. And the best place to deal with diverse user traffic is at the edge of the ISP network

(i.e., provider edge or PE routers). As a result PE routers tend to have high degrees. Therefore, we believe the star-like topology is very generic and prevalent in large ISP backboneExt networks.

With such large-scale star-like topology and given certain measurement constraints, the monitor selection algorithms introduced before usually select a large number of monitors, e.g., thousands of monitors. To reduce the monitor installation cost while maintaining the measurement constraints, the simplest approach is to reduce the measurement frequency on each measured path. For example, assume originally in the measurement phase we measure the loss rate of a path for three minutes with probe frequency of four packets/second. Now if we measure the path for six minutes with probe frequency two packets/second, it is equivalent to double the number of paths that a monitor can measure. However, low probe frequency usually leads to less accurate peak (short term) loss rate measurement, and the average loss rates within a long period cannot reflect the nature of congestion of network traffic. Therefore, in one preferred embodiment, the system keeps the original probe frequency while scheduling path measurement in different time periods to avoid violating measurement constraints.

### 2.2.2 Basic Approach for Multi-Round Monitoring

The main idea of our multi-round monitoring is as follows: we consider R rounds of back-to-back measurements and in each measurement round different paths are measured by the selected monitors. Finally, all the links are covered by at least one of the R rounds of measurements. The multi-round monitor selection algorithm tries to minimize the number of monitors that can cover all the links in a certain number of rounds (R).

In one preferred embodiment, the system uses a two-step solution for the multi-round monitor selection problem. First the system converts the multi-round selection problem to the single-round selection problem while multiplying the monitor's constraints and link bandwidth constraints by the round number R. In this step, the system obtains the selected monitors as well as paths to be measured. In the second step, the system schedules the paths to be measured in the R rounds appropriately, trying to satisfying the constraints of each round. Note that node constraints are easy to satisfy because monitors are independent in terms of the node constraints. However in some extreme cases, there may be some link constraint violations in some rounds even if we have the optimal scheduling algorithm. Therefore, in such cases, the scheduling algorithm tries to minimize the constraint violations. In one preferred embodiment, the system defines the link violation degree of a link as b−1(n>b) where n is the scheduled number of paths over the link and b is the link constraint of the link. The system then uses two metrics that quantify the violation degree: 1) maximum link violation degree (MLVD); 2) total link violation degree (TLVD).

As the single-round monitor selection problem is discussed in the previous section, the path scheduling problem is further discussed in this section. It is worth mentioning that the path scheduling problem itself is also an NP-hard problem. In one preferred embodiment, the system applies three techniques to the path scheduling problem: randomized algorithm, greedy algorithm and integer linear programming with relaxation.

### 2.2.3 Simple Randomized Algorithms

For any path p to be measured, we simply randomly select a round of the R rounds and schedule to measure the path p in this round. To do the random scheduling for a path, the system uses a random function which generates a number t within [0, R] with uniform distribution. Suppose the integer number k satisfies k−1≦t<k, then the system identifies the path to be measured in the kth round.

In the sense of expectation, the randomized scheduling results comply to the monitor's constraints and link bandwidth constraints in each round. For example, the monitor i will monitor no more than N×cᵢ paths in total, hence in every round at most cᵢ paths from the monitor i are expected to be measured. However, for example, in a randomized instance, a monitor may monitor paths more than expected and hence the node constraint is violated. Similarly, the system applies Theorem 2 to quantify the violation degree and possibility for node constraints and link constraints (details omitted).

### 2.2.4 Greedy Algorithm

The second algorithm used by the system is a greedy algorithm. Basically, the greedy algorithm adds paths to the possible rounds of measurement, trying to minimize the violations of the system's constraints. It is easy for a greedy algorithm to schedule the path measurement so that monitor's constraints are all satisfied. However, link constraint violations may happen in some cases. Therefore, the object function of the greedy algorithm is to minimize the maximum link violation degree or the total link violation degree of all the links. In each step, the greedy algorithm selects a path in the measurement set which will minimize the current maximum link violations and puts the path to a certain round.

### 2.2.5 LP Based Randomized Algorithm

The third algorithm used by the system is to use integer linear programming first, and then use the relaxation and random round algorithm described previously to convert it to linear programming. The objective function is minimizing the maximum link violation degree or the total link violation degree, which is the same as the greedy algorithm discussed above. yᵢⱼᵣ=1 if path Pᵢⱼ is scheduled to be measured in round r, and yᵢⱼr=0 otherwise. The integer linear programming is formulated to minimize the maximum link violation degree:

P: Minimize v

s.t. Σᵣyᵢⱼᵣ=1, ∀i, j

Σⱼyᵢⱼᵣ≦cᵢ, ∀i

Σ yᵢⱼᵣ−bₖ≦v×bₖ, ∀k,r (8)

∀i, ∀j, LₖεPᵢⱼ

yᵢⱼᵣ ε {0, 1}

The first line means one path can just be measured in one round, since it does not need to measure the same path twice at one time. The second and third line specifies node constraint and link constraint correspondingly. Minimizing the total link violation degree is similarly done.

Having described the algorithms for selecting routers to install monitors. After monitors are installed, the system continuously monitors the performance of the backboneExt networks round by round. Each round contains the following two stages:

Stage 1: Path monitoring. the monitor selection algorithm gives the set of monitors and paths to measure in order to cover all (or majority of) the links spanning the backbone network paths under the operational constraints. In the first stage, the system instruments these monitors to measure the selected path and collect the measurement information.

Stage 2: Faulty link diagnosis. If paths are identified as faulty in the first stage, there must be faulty links on those paths. In the second stage, the system diagnoses which links are faulty. Although we can try to infer the lossy links solely based on the measurement results of the first stage with existing approaches, the measurements are often insufficient to give the best diagnosis granularity or accuracy for the specific faulty paths.

Based on the observation that Internet congestions usually have some constancy, the system selects a minimal extra set of paths to measure which, when combined with the first stage measurement results, gives the best diagnosis granularity and accuracy. For diagnosis, the system focuses on loss rate inference but the techniques used can also be extended to other metrics such as delay.

### 3.1 Path Monitoring Stage

In the path monitoring stage, monitors send out probes on the pre-selected paths to measure path properties. Measurements from different monitors are expected to be executed during the same period. In the system, a coordinator first assigns the measurement tasks to all the monitors (not necessary for it to be done simultaneously). Then at the beginning of the path monitoring stage, the coordinator sends a START command to all the monitors at nearly the same time. This ensures that all the monitors start the measurements within a short period. In case there are network dynamics, the system may need to re-select the paths to ensure link coverage. We discuss more details about path re-selection below.

### 3.2 Faulty Link Diagnosis Stage

After faulty paths are reported in the first stage, the system selects the minimal number of extra paths to measure in order to locate the faulty links. In one preferred embodiment, the system uses a linear algebra based approach to select the minimal number of paths which, when combined with the paths measured in stage 1, can provide the complete loss information about the networks and consequently the best diagnosis granularity and accuracy. We will first give the background on the linear algebra model, and then introduce the algorithms utilized by the system.

### 3.3.1 Background on the Linear Algebra Model

Suppose that a backbone network consists of s IP links. In the linear algebra model, a path is represented by a column vector v E {0, 1}⁸, where the jth entry vⱼ is 1 if link j is on the path and 0 otherwise. Suppose link j drops packets with probability lⱼ. Then the loss rate p of a path represented by v is given by

$$1 - p = {\prod }_{j = 1}^{s} {( 1 - {l}_{j} )}^{{v}_{j}} \qquad ( 9 )$$

By taking logarithms on both sides of (9), we have

$$log ( 1 - p ) = {\sum }_{j = 1}^{s} {v}_{j} log ( 1 - {l}_{j} ) = {\sum }_{j = 1}^{s} {v}_{j} {x}_{j} = {v}^{T} x \qquad ( 10 )$$

where x ε [symbol] is a column vector with elements xⱼ=log(1−lⱼ) and v^{T} is the tranpose of the row vector v.

Through the above transformations we can get a linear system as following. Given the installed monitors and traffic isolation constraints, if there are r measurable paths in the backbone network, then we can form a rectangular matrix G ε {0, 1}^{r×x}. Each row of G represents a measurable path in the network: Gig=1 if path i contains link j, and Gᵢⱼ=0 otherwise. Let pᵢ be the end-to-end loss rate of the ith path, and b ε [symbol] be a column vector with elements xⱼ=log(1−lⱼ). Then we have

Gx=b (11)

The above linear algebraic model is also applicable for any additive metric, such as delay.

### 3.3.2 Incrementally Selecting Paths for Diagnosis

Given the measurement results of the path monitoring phase, the system applies the good path algorithm to find out potential lossy links. The good path algorithm simply considers that all the links on non-lossy paths are also non-lossy and hence removes these good links and paths. Next, the system obtains a path set which include all the paths that contain at least one potential lossy link. The path matrix of these paths is identified as G′. The basis of the matrix G′, G′, contains the same amount of information as the whole G′ matrix for inferring the link level loss rates. Thus the system just needs to determined the paths corresponding to a basis for the diagnosis purpose. At the same time, it is desirable for all the paths to be measured simultaneously so that the faulty link(s) can be located quickly. That is, the additional selected paths satisfy the node/link measurement constraint.

The constrained basis selection problem is NP-hard, and sometimes it may not have a solution. Accordingly, the system uses a greedy algorithm to address this issue that operates as follows:

For each unmeasured path, the system first obtains its path measurement capacity by taking the minimum of the node constraints of the source and destination nodes, and the link constraints of the all the links on the path. For example, if the source node can measure 10 paths, the destination node can measure 20 paths, and there are two links on the paths whose constraints translates to 12 and 8 paths respectively, then the measurement capacity calculated by the system of the path is 8.

The system sorts these paths by the path measurement capacity (denoted as cᵢ for path i). G′ is set to be empty at the beginning. Then starting from the path with the largest cᵢ, the system iteratively attempts to add the path (denoted as a vector v) to G′ if v can expand the basis of G′. If so, the system selects path v, updates the remaining capacity of the nodes and links, and then selects the next path with the largest path measurement capacity.

The system stops the iteration when the rank of Q is the same as the rank of G, or the system runs out of paths, i.e., the greedy algorithm does not find the extra paths which can constitute a basis with Q, under these constraints.

In one implementation, the system uses the basis expanding algorithm but extends it with path selection priority and constraint satisfactory inspection. The computational complexity is 0(rk²) where r is the number of paths in G′ and k is the rank of G′. In practice, our experiment shows the algorithm finishes in less than 20 s for dealing with G′ of thousands of paths.

In another preferred embodiment, the system uses the Bayesian experimental design which designs measurement experiments maximizing information gain about network path properties for path selection in the faulty path diagnosis. The Bayesian experimental design can potentially give the best results/ under certain total measurement budgets.

### 3.3.3 Locating Faulty Links

After collecting measurement results of the newly selected paths in this stage, the system next locates the faulty links. There are several existing works on diagnosis analysis which can be applied in the system. Among them, the Minimal Identifiable Link Sequence (MILS), which is defined as a link sequence of minimal length whose properties can be uniquely identified from end-to-end measurements, requires the least statistical assumptions, compared with most existing network tomography work. In one preferred embodiment, the system extends MILS by introducing Minimal Identifiable Link Unit (MILU), a smaller diagnosis unit than MILS under the same statistical assumptions.

Minimal Identifiable Link Sequence (MILS) is defined as the smallest diagnosis unit with the least bias introduced. However, the definition of MILS has some limitations: 1) a MILS is a consecutive link sequence; 2) the vector corresponding to a MILS has the coefficients of only 0 or I. In one preferred embodiment, the system uses an improved algorithm to relax the above two constraints and achieve “smaller” diagnosis units, called Minimal Identifiable Link Unit (MILU). For example, a MILS may contain three consecutive links I₁, I₂ and I₃ on a path. When the consecutive assumption is removed, the system can identify a MILU containing only links I₁ and I₃, which is shorter than the original MILS.

Assume the path matrix is G and v* is the vector that corresponds to the MILU containing the target virtual link. Without loss of generality, we assume the first virtual link is the target. So v*=[1, v*₂, . . . , v*₁]. Then we have:

v*=v: v₁=1, v ε [symbol] (G), and |v|₁ is minimized

R(G) is the row space of the matrix G. To find out the MILU of a link, the system solves the following linear programming:

$$P \text{:} {minimize}_{s . t .} {{\sum }_{i = 1}^{l} \vert {v}_{i} \vert}_{{G}^{T} x = v} \qquad ( 12 )$$

This linear programming minimizes

$$r = {\sum }_{i = 1}^{l} \vert {v}_{i} \vert ,$$

which is the unwanted part when the system targets the first virtual link. If the first virtual link itself is a MILS, then the redundant part is 0. Otherwise, r is positive. To find out the MILU for all the suspicious faulty links on a faulty path, the system executes the above linear programming multiple times to calculate the MILU for these links.

### 4.0 Robustness and Adaptivity in Dynamic Scenarios

When the backbone topology changes as the backbone network expands, routing changes may occur when routers or links fail. Therefore, the system is robust against temporary or permanent changes and is adaptive to the dynamics in the network.

### 4.1 Redundancy in Monitor Selection

Selecting redundant monitors are necessary to assure that system handles well the various dynamics in the network for the following reasons. First of all, a monitor or the router that the monitor is attached to may fail. As a result, some previously covered links might not be covered by any path of the remaining monitors. Secondly, new routers or links can be added into the network after the monitor selection has been done. Installing new monitors to cover the newly added links every time is costly and annoying.

A straightforward way to introduce redundancy is to require each link to be covered by multiple paths. Therefore, a small number of routing changes may not break the full coverage of links. To achieve such redundancy, the greedy algorithm is modified on calculating the progress of the new paths. As for the LP based algorithm, Inequality (4) is modified such that each link is covered by at least a certain number of paths.

Furthermore, considering the possibility of the failure of monitors, the system require that the multiple paths covering the same link are from two or more different monitors if possible. Again, greedy algorithm can be extended easily to achieve such redundancy. The LP based algorithm described previously may also be able to assure the monitor redundancy.

### 4.2 Reselecting Paths for Path Monitoring Stage

When the set of monitors change, or the set of paths of a monitor changes as the result of routing changes (such as OSPF weight change), the coordinator has to re-select the paths to measure for the path monitoring stage and redistribute the task assignment to all the monitors.

First, the measurement path selection is a simpler problem than the monitor selection because it is a special case of the monitor selection problem when the monitors are fixed. In one preferred embodiment, the system uses the monitor selection algorithms presented in previous sections for this purpose. However, in another preferred embodiment, an incremental adjustment is made because incremental algorithms usually have less computational complexity and introduce less communications overhead. The communication overhead is due to the communication messages through which the coordinator distributes the measurement tasks to all the monitors. Since some incremental update can be used for the task distribution, the communication overhead is proportional to the change in the measurement tasks. As mentioned previously, some monitors have unused measurement capacity for redundancy purpose. Therefore, when a link is no longer covered due to a routing change, the system first applies a simple heuristic algorithm on all paths containing the target link. If monitor Al* has the ability to measure one more path P* containing the target link, then the system adds P* into M*'s measurement task. On the other hand, if the heuristic algorithm fails, this can indicate that some large-scale adjustments are necessary and the system re-selects the paths to measure from scratch. The system can also apply this heuristic algorithm in the case of monitor failure.

What is claimed is:

1. A method for monitoring and diagnosing a back-bone network having access links and customer routers comprising:
selecting a monitor from said plurality of customer routers and data paths to be measured by said monitor; and
detecting a link failure between said customer routers in response to measurement information received from said monitor.

2. The method of claim 1, comprising selecting a plurality of monitors from said customer routers, each of said plurality of monitors selecting a subset of data paths to measure such that a majority of data links of said back-bone network is included in at least one measured path.

3. The method of claim 2, comprising probing iteratively data paths associated with each of said plurality of monitors.

4. The method of claim 2, further comprising:
assigning measurement tasks to each of said monitors; and
collecting measurement results from said monitor.

5. The method of claim 1, comprising selecting said monitor using a greedy algorithm.

6. The method of claim 1, comprising selecting said monitor using relaxed linear programming.

7. The method of claim 1, comprising selecting a minimum number of additional data paths to measure in response to receiving said measurement information.

8. The method of claim 7, further comprising combining said minimum number of additional paths with said measurement information to identify said link failure.

9. The method of claim 8, comprising using a liner algebra technique for selecting said minimum number of additional data paths.

10. The method of claim 9, comprising detecting said link failure on a data path using at most two links.

11. A system for monitoring and diagnosing a back-bone network having access links and customer routers comprising:
a monitor module arranged to select a monitor from said plurality of customer routers and data paths to be measured by said monitor; and
a diagnosis module arranged to detect a link failure between said customer routers in response to measurement information received from said monitor.

12. The system of claim 11, wherein said monitor module selects a plurality of monitors from said customer routers, each of said plurality of monitors selecting a subset of data paths to measure such that a majority of data links of said back-bone network is included in at least one measured path.

13. The system of claim 12, wherein each of said plurality of monitors iteratively probes data paths associated with itself.

14. The system of claim 12, further comprising a coordination module adapted to 1) assign measurement tasks to each of said monitors and 2) collect measurement results from said monitor.

15. The system of claim 11, wherein said monitor module selects said monitor using a greedy algorithm.

16. The system of claim 11, wherein said monitor module selects said monitor using relaxed linear programming.

17. The system of claim 11, wherein said diagnosis module selects a minimum number of additional data paths to measure in response to receiving said measurement information.

18. The system of claim 17, wherein said diagnosis module combines said minimum number of additional paths with said measurement information to identify said link failure.

19. The system of claim 18, wherein said diagnosis module uses a liner algebra technique to select said minimum number of additional data paths.

20. The system of claim 19, wherein said diagnosis module detects said link failure on a data path having at most two links.
